(19) United States
(12) Patent Application Publication
(10) Pub. No.: US 2006/0139510 A1
(43) Pub. Date: Jun. 29, 2006

(54) Liquid crystal display device with static electricity damage prevention

(75) Inventors: Tsung Ping Liao, Miao-Li (TW); Hsueh Tien Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/320,042

(22) Filed: Dec. 28, 2005

(30) Foreign Application Priority Data
Dec. 28, 2004 (TW) 93221035

(51) Int. Cl. G02F 1/1333

(52) U.S. Cl. 349/58

(57) ABSTRACT

A liquid crystal display device (1) includes a liquid crystal display panel (10), a flexible printed circuit (14), and a frame assembly (16). The liquid crystal display panel includes a first substrate (102), a second substrate (104) opposite to the first substrate, and a liquid crystal layer (106) disposed between the first and second substrates. The flexible printed circuit is electrically connected to the second substrate. The frame assembly receives the liquid crystal display panel, and includes a conductive element (176) electrically connected to the flexible printed circuit. The liquid crystal display device includes the conductive element electrically connected to the grounded flexible printed circuit, which enables to conveniently prevent the liquid crystal display panel from being damaged by static electricity.

### FIELD OF THE INVENTION

The present invention relates to liquid crystal display devices, and more particularly to a liquid crystal display device resistant to damage from static electricity.

### GENERAL BACKGROUND

Liquid crystal displays (LCDs) are commonly used as display devices for compact electronic apparatuses, because they not only are very thin but also provide good quality images with little power consumption.

Referring to FIG. 2, a conventional liquid crystal display device 5 includes a liquid crystal display panel 50, a backlight module 52 disposed adjacent to the liquid crystal display panel 50, a conductive device 54, and a frame 56 containing the liquid crystal display panel 50, the backlight module 52, and the conductive device 54.

The liquid crystal display panel 50 includes a first substrate 502, a second substrate 504 disposed opposite to the first substrate 502, a liquid crystal layer 506 disposed therebetween, and a driving circuit 501 electrically connected to the second substrate 504.

The driving circuit 501 is disposed adjacent to the liquid crystal layer 506, and includes a driving integrated circuit (IC) 503 and a protective layer 505 covering the driving IC 503.

The conductive device 54 is disposed adjacent to the protective layer 505 of the driving circuit 501, and includes a conductive layer 542 and an elastic conductive layer 544 adjoining the conductive layer 542. The conductive layer 542 is electrically connected to a grounding part (not labeled) of the driving circuit 501. The elastic conductive layer 544 is electrically connected to the frame 56 and the conductive layer 542. The elastic conductive layer 544 is made from conductive foam.

The conductive device 54 can prevent the liquid crystal display panel 50 from being damaged by static electricity. However, the structure of the elastic conductive layer 544 and the conductive layer 542 make manufacturing of the liquid crystal display device 5 more complex.

What is needed, therefore, is a liquid crystal display device that can overcome the above-described deficiency.

### SUMMARY

A liquid crystal display device includes a liquid crystal display panel, a flexible printed Circuit, and a frame assembly. The liquid crystal display panel includes a first substrate, a second substrate opposite to the first substrate, and a liquid crystal layer disposed between the first and second substrates. The flexible printed Circuit is electrically connected to the second substrate. The frame assembly receives the liquid crystal display panel, and includes a conductive element electrically connected to the flexible printed circuit. The flexible printed circuit is grounded.

The liquid crystal display device includes the conductive element electrically connected to the grounded flexible printed circuit, which prevents the liquid crystal display panel from being damaged by static electricity.

Other advantages and novel features will become more apparent from the following detailed description when taken in conjunction with the accompanying drawings.

### BRIEF DESCRIPTION OF THE DRAWINGS

FIG. 1 is part of a schematic, side cross-sectional view of part of a liquid crystal display device according to a preferred embodiment of the present invention.

FIG. 2 is a schematic, side cross-sectional view of part of a conventional liquid crystal display device.

### DETAILED DESCRIPTION OF PREFERRED EMBODIMENTS

Reference will now be made to the drawings to describe the preferred embodiments in detail.

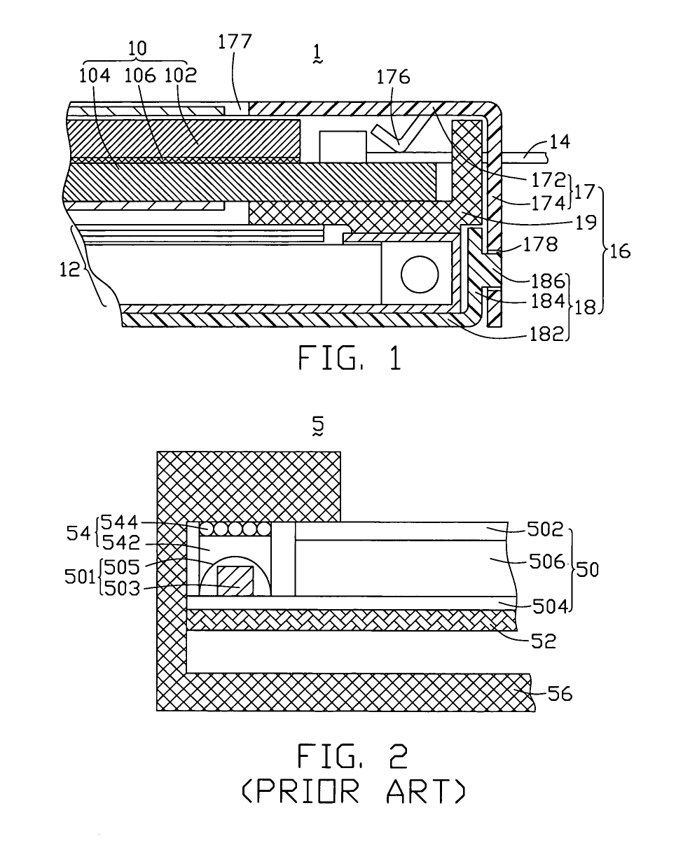

FIG. 1 is a schematic, side cross-sectional view of part of a liquid crystal display device according to a preferred embodiment of the present invention. The liquid crystal display device 1 includes a liquid crystal display panel 10, a backlight module 12 disposed adjacent to the liquid crystal display panel 10, a flexible printed circuit (FPC) 14, and a frame assembly 16 containing the liquid crystal display panel 10 and the backlight module 12.

The liquid crystal display panel 10 includes a first substrate 102, a second substrate 104 disposed opposite to the first substrate 102, and a liquid crystal layer 106 disposed therebetween. The FPC 14 is electrically connected to the second substrate 104 of the liquid crystal display panel 10, and the FPC 14 is grounded.

The frame assembly 16 includes a top frame 17, a bottom frame 18 opposite to the top frame 17, and a support frame 19 disposed therebetween. The support frame 19 can be made from plastic or other suitable material. The top frame 17 includes a top wall 172, a pair of side walls 174 (only one shown) adjoining the top wall 172, and a conductive element 176 integrated with the top wall 172. In the illustrated embodiment, the conductive element 176 is in the form of an L-shaped spring finger extending obliquely down from the top wall 172. In other embodiments, the conductive element can have other suitable forms. The top wall 172 includes an opening 177 corresponding to a display area (not labeled) of the liquid crystal display 10. Each side wall 174 includes a hole 178. The bottom frame 18 includes a bottom wall 182, and a pair of side walls 184 (only one shown) adjoining the bottom wall 182. Each side wall 184 includes an protrusion 186 corresponding to the hole 178 of the top frame 172. The support frame 19 is disposed between the backlight module 12 and the liquid crystal display panel 10. The top frame 17 and the bottom frame 18 can be made from metal, such as iron, magnesium, or aluminum.

The holes 178 of the top frame 17 and the protrusions 186 of the bottom frame 18 cooperate to fix the top frame 17 and the bottom frame 18 together. The support frame 19 is supported by the side walls 184 of the bottom frame 18. The conductive element 176 is elastically in contact with the FPC 14.

In summary, the liquid crystal display device 1 includes the conductive element 176 integrated with the top frame 17 and elastically connected to the grounded FPC 14. If static electricity accumulates on the liquid crystal display panel 10, the conductive element 176 allows the static charge to dissipate to the FPC 14, thereby preventing the liquid crystal display panel 10 from being damaged by static electricity. Further, it is relatively simple to manufacture and assemble the liquid crystal display device 1.

In an alternative embodiment, the conductive element 176 may be attached to rather than integrated with the top frame 17. In other alternative embodiments, the conductive element 176 can be replaced by a plurality of conductive foam portions attached to the top frame 17.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display device, comprising:
a liquid crystal display panel, comprising:
a first substrate;
a second substrate opposite to the first substrate;
a liquid crystal layer disposed between the first and second substrates;
a grounded flexible printed circuit electrically connected to the second substrate; and
a frame assembly containing the liquid crystal display panel, and comprising a conductive element electrically connected to the flexible printed circuit.

2. The liquid crystal display device as claimed in claim 1, wherein the frame assembly comprises a first frame and a second frame opposite to the first frame.

3. The liquid crystal display device as claimed in claim 2, wherein the first frame comprises a top wall and a first side wall adjoining the top wall.

4. The liquid crystal display device as claimed in claim 3, wherein the conductive element is provided at the top wall.

5. The liquid crystal display device as claimed in claim 4, wherein the conductive element is integrated with the top wall.

6. The liquid crystal display device as claimed in claim 4, wherein the conductive element is attached to the top wall.

7. The liquid crystal display device as claimed in claim 1, wherein the conductive element is elastic.

8. The liquid crystal display device as claimed in claim 1, wherein the conductive element is made from conductive foam.

9. The liquid crystal display device as claimed in claim 3, wherein the first side wall comprises a hole.

10. The liquid crystal display device as claimed in claim 9, wherein the second frame comprises a bottom wall and a second side wall adjoining the bottom wall.

11. The liquid crystal display device as claimed in claim 10, wherein the second side wall comprises an protrusion corresponding to the hole of the first side wall.

12. The liquid crystal display device as claimed in claim 2, wherein the first and second frames are made from metal.

13. The liquid crystal display device as claimed in claim 12, wherein the first and second frames are made from iron, magnesium, or aluminum.

14. The liquid crystal display device as claimed in claim 1, further comprising a backlight module disposed generally adjacent to the liquid crystal panel.

15. The liquid crystal display device as claimed in claim 14, wherein the frame assembly further comprises a third frame disposed between the liquid crystal display panel and the backlight module.
